(19) United States
(12) Patent Application Publication
(10) Pub. No.: US 2022/0297083 A1
(43) Pub. Date: Sep. 22, 2022

(54) Continuous Synthesis Of Porous Coordination Polymers In Supercritical Carbon Dioxide

(71) Applicant: University of Washington, Seattle, WA (US)

(72) Inventors: Elizabeth G. RASMUSSEN, Seattle, WA (US); John C. KRAMLICH, Seattle, WA (US); Igor V. NOVOSSELOV, Seattle, WA (US)

(21) Appl. No.: 17/639,248

(22) PCT Filed: Aug. 27, 2020
(86) PCT No.: PCT/US2020/048283

§ 371 Date: Feb. 28, 2022

Related U.S. Application Data
(60) Provisional application No. 62/892,340, filed on Aug. 27, 2019.

(51) Int. Cl. B01J 20/22; B01J 3/00; B01J 20/28; B01J 20/30

(52) U.S. Cl. CPC B01J 20/226; B01J 3/008; B01J 20/28004; B01J 20/28066; B01J 20/28071; B01J 20/3078; B01J 20/3085

(57) ABSTRACT

This disclosure relates generally relates to methods and systems useful for continuous synthesis of materials in super-critical carbon dioxide (sCO₂). More particularly, this disclosure relates to methods and systems useful for continuous synthesis of coordination polymers, such as metal-organic frameworks (MOFs) and/or covalent organic frameworks (COFs), in sCO₂.

### CROSS-REFERENCE TO RELATED APPLICATIONS

This application claims priority to U.S. Patent Application No. 62/892,340 filed Aug. 27, 2019, the disclosures of which is explicitly incorporated by reference herein.

### STATEMENT REGARDING FEDERALLY SPONSORED RESEARCH OR DEVELOPMENT

This invention was made with government support under Grant No. HDTRA1-17-1-0001, awarded by the Defense Threat Reduction Agency, and Grant No. NNCI-1542101, awarded by the National Science Foundation. The government has certain rights in the invention.

### BACKGROUND OF THE DISCLOSURE

### Field of the Disclosure

This disclosure relates generally relates to methods and systems useful for continuous synthesis of materials in supercritical carbon dioxide (sCO₂). More particularly, this disclosure relates to methods and systems useful for continuous synthesis of coordination polymers, such as metal-organic frameworks (MOFs) and/or covalent organic frameworks (COFs), in sCO₂.

### Technical Background

Metal-organic frameworks, MOFs, are a family of materials with porous structures and high surface areas. These material characteristics are desirable for a wide range of applications, such as catalysis, gas storage, and drug delivery. Even with such exciting opportunities, current MOF synthesis methods are time-consuming, costly, and produce toxic waste, resulting in unscalable production. MOFs are commonly synthesized in solvothermal batch processes. To promote widespread adoption, MOF synthesis must move toward large scale manufacturing methods that are fast, environmentally friendly, and economically favorable.

Continuous-flow methods are very attractive for industrial production compared to batch reactors. Many continuous technologies have been explored for MOF synthesis in the past decade, including mechanochemical, microwave-assisted, spray drying, hydrothermal, supercritical water, and microfluidic technologies, each with its own set of advantages and disadvantages. Accordingly, there is a need in the art for novel methods and systems for synthesizing MOFs that are efficient, cost-effective, and environmentally friendly.

### SUMMARY OF THE DISCLOSURE

One aspect of the disclosure provides methods of preparing coordination polymer compositions under continuous flow conditions. Such methods include:
providing a supercritical CO₂ and one or more coordination polymer precursors to a mixing section to obtain a mixture of the supercritical CO₂ and one or more coordination polymer precursors; and
providing the mixture to a continuous flow reactor for a period of time sufficient to obtain the coordination polymer composition.

Another aspect of the disclosure provides systems that are useful to carry out the methods of the disclosure. Such systems include:
a mixing section having a first inlet connected to a precursor supply, a second inlet connected to a supercritical CO₂ supply, and a first outlet; and
a continuous flow reactor having an inlet connected to the outlet of the mixing section and an outlet.

Another aspect of the disclosure provides a coordination polymer prepared by a method of the disclosure as provided herein.

### BRIEF DESCRIPTION OF THE DRAWINGS

The accompanying drawings are included to provide a further understanding of the systems and methods of the disclosure, and are incorporated in and constitute a part of this specification. The drawings illustrate one or more embodiment(s) of the disclosure and, together with the description, serve to explain the principles and operation of the disclosure.

FIG. 1 shows continuous-flow MOF synthesis reactor using scCO₂ to synthesize the zirconium-based MOF UiO-66 with the reactor with components, including thermocouple (TC) and back pressure regulator (BPR), identified.

FIG. 2 is a schematic of the counter-current mixing section with vapor-liquid equilibrium phases outlined.

FIG. 3 shows SEM images of synthesized UiO-66 nanoparticles (a) smaller UiO-66 particles (b) more dispersed UiO-66 particles highlighting particles of a larger size.

FIG. 4 shows physisorption characteristics of UiO-66 MOF prepared in continuous-flow synthesis reactor with scCO₂ injection at 393 K and10 MPa (a) N₂ adsorption and desorption isotherms (b) Pore size distribution based on Horvath-Kawazoe method.

FIG. 5 shows experimental and theoretical powder X-ray diffraction (PXRD) patters of UiO-66 MOF.

FIG. 6 shows a plot of temperature for the different reactor sections during synthesis.

FIG. 7 is a schematic of the counter-current mixing section with design variables identified.

### DETAILED DESCRIPTION OF THE DISCLOSURE

The inventors recognized that MOF synthesis in a supercritical environment shows great promise as a scalable manufacturing approach. Production rates were found to be over ten times higher than other continuous-flow methods, and synthesis occurred in seconds as opposed to tens of hours. A supercritical environment is also appealing because near the solvent's critical point, the thermodynamic properties vary significantly with small changes in pressure or temperature. This tunability of supercritical fluid properties can affect nanoparticle nucleation. So far, water (H₂O) has been the supercritical fluid of choice for nanomaterial synthesis, including MOFs. A disadvantage of supercritical water (scH₂O) is its high critical temperature and pressure values (620 K, 22.1 MPa), which results in large process energy consumption and expensive materials of construction. The high critical temperature of scH₂O also causes the thermal degradation of some MOF precursor materials. For example, N,N-dimethylformamide (DMF) is frequently used in MOF synthesis because of useful acid-base chemistry and high boiling point, and decomposes at about 623 K, causing ligand defects in MOFs. Additionally, in scH₂O, precursor materials are subject to hydrolysis degradation. This thermal and hydrolysis precursor degradation limits the potential of scH₂O based continuous-flow reactors to synthesize a wide range of MOFs. Recognizing that many common MOF recipes suffer from precursor degradation, Chen et al. (CrystEngComm 2019, 21(14):2409-2415) reported a batch process performed at room temperature, that requires 48 h with the reported production rate of 0.417 gh⁻¹.

In comparison to scH₂O, supercritical carbon dioxide (scCO₂) has a lower critical point (304 K, 7.31 MPa). The present inventors recognized that a scCO₂ based MOF synthesis method consumes less energy, has a lower reactor construction cost, and avoids the precursor degradation disadvantages of scH₂O. The inventors also recognized that scCO₂ systems allows for the natural separation of the MOF from the effluent, resulting in easy recycling of solvents, and decreasing waste streamflow. Thus, the present disclosure provides methods and systems that use scCO₂ for scalable continuous-flow MOF synthesis and overcome the disadvantages of scH₂O.

Historically, continuous-flow scCO₂ processes focused on applications involving botanical extraction, coal gasification, and turbomachinery power cycles—not on the synthesis of complex materials such as MOFs. Recently in a batch process, scCO₂ was used to synthesize MOFs, but in addition to being non-continuous, the method also had long reaction times, ranging between 3 and 90 h. In contrast to the batch method, a continuous-flow process requires the management of phase changes occurring in the reactor. Additionally, because thermodynamic properties vary significantly near the critical point, design decisions must consider these nonlinearities. Failure to recognize the complex physics near the critical point could lead to faulty, unsafe, and unsuccessful reactor operation.

Thus, one aspect of the disclosure provides a method of preparing a coordination polymer composition under continuous flow conditions. Such methods include:
providing a supercritical carbon dioxide (CO₂) and one or more coordination polymer precursors to a mixing section to obtain a mixture of the supercritical CO₂ and one or more coordination polymer precursors; and
providing the mixture to a continuous flow reactor for a period of time sufficient to obtain the coordination polymer composition.

The present inventors found that the methods of the disclosure are particularly suitable for preparing coordination polymers that are metal-organic framework, covalent organic framework (COF), or a combination thereof (i.e., a hybrid of MOF and COF). In certain embodiments, the coordination polymer is MOF. One of skill in the art recognized that these materials also include any subclasses of these materials. For example, the term MOF would also include bio-MOFs that are composed of biomolecules (amino acids, nucleobases, sugars, etc.) as the linkers, which are generally referred to as metal-biomolecular frameworks (MBioFs). The term MOF would also include MOFs that are composed of imidazole based linkers coordinated to transition metal ions of tetrahedral disposition and are generally referred to as zeolitic imidazolate frameworks (ZIFs).

In the methods and systems of the disclosure the reactor is maintained at a temperature sufficient to obtain the coordination polymer composition and/or maintain supercritical conditions. In certain embodiments, the reactor is maintained at a temperature sufficient to maintain supercritical conditions. For example, in certain embodiments, the sufficient temperature is in a range of 30° C. to 600° C. In certain embodiments, the temperature is in a range of 80° C. to 160° C., or 100° C. to 140° C., or 110° C. to 130° C., or 120° C.

To maintain supercritical conditions, in certain embodiments, the reactor is maintained at a sufficient pressure. For example, in certain embodiments, the sufficient pressure is in a range of 7.3 MPa to 30 MPa. In certain embodiments, the pressure is in a range of 7.3 MPa to 20 MPa, 7.3 MPa to 15 MPa, 8 MPa to 12 MPa, 9 MPa to 11 MPa, or 10 MPa.

In certain embodiments as otherwise described herein, the reactor is maintained at a temperature in a range of 90° C. to 150° C. and at a pressure in a range of 8.5 MPa to 11 MPa. In certain embodiments, the reactor is maintained at a temperature in a range of 110° C. to 130° C. and at a pressure in a range of 9 MPa to 11 MPa.

The present inventors have found that continuous flow conditions have several benefits. These benefits, for example, can be tuned with adjusting the flow rate and/or period of time. Thus, in certain embodiments as otherwise described herein, the mixture is provided to the reactor at a flow rate of 0.1 mL/min to 100 mL/min. For example, in certain embodiments, the mixture is provided to the reactor at a flow rate of 0.1 mL/min to 50 mL/min, or 1 mL/min to 30 mL/min. The mixture may also be provided for a period of time sufficient to obtain the coordination polymer composition. Such period of time, in certain embodiments, is in a range of 0.01 second to 20 minutes. For example, in certain embodiments, the mixture is provided to the reactor for a period of time in a range of 0.1 second to 10 minutes, or 1 second to 10 minutes, or 1 minute to 10 minutes, or 0.01 seconds to 60 seconds, or 0.1 second to 60 seconds, or 1 second to 60 seconds, or 0.01 seconds to 30 seconds, or 0.1 second to 30 seconds, or 1 second to 30 seconds, or 0.01 seconds to 10 seconds, or 0.1 second to 10 seconds, or 1 second to 10 seconds, or 1 second to 5 seconds. In certain embodiments, the mixture is provided to the reactor for a period of time in a range of 0.01 second to 30 minutes, such as 1 second to 30 minutes, 10 seconds to 30 minutes, 1 minute to 30 minutes, 10 minutes to 30 minutes, or 20 minutes to 30 minutes. In certain embodiments, the mixture is provided to the reactor for a period of time in a range of 30 minutes to 4 hours, such as 30 to 60 minutes, or 30 to 2 hours, or 30 to 3 hours, or 1 hour to 4 hours, or 2 hours to 4 hours.

The inventors recognized that the supercritical conditions allow the reaction to take place in homogeneous media, thus increasing the synthesis rates. Thus, in certain embodiments as otherwise described herein, the mixture of the supercritical CO₂ and one or more coordination polymer precursors comprises substantially homogeneous medium.

The methods of the disclosure, in certain embodiments, further comprise providing gaseous CO₂ at a temperature and/or pressure sufficient to form liquid CO₂, and maintaining liquid CO₂ at pressure and/or temperature sufficient to form supercritical CO₂. In certain other embodiments, the methods further comprise providing gaseous CO₂ at a temperature and/or pressure sufficient to form supercritical CO₂.

One embodiment of the disclosure is a method wherein the supercritical CO₂ is provided to the mixing section at a flow rate of 0.1 mL/min to 100 mL/min (e.g., 1 mL/min to 50 mL/min). Another embodiment of the disclosure is a method wherein the one or more coordination polymer precursors is provided to the mixing section using a pump at a flow rate of 0.1 mL/min to 100 mL/min (e.g., 1 mL/min to 30 mL/min).

In certain embodiments of the methods of the disclosure, CO₂ may be removed after obtaining the coordination polymer composition. For example, in certain embodiments, the CO₂ may escape naturally.

The methods of the disclosure may also result in the coordination polymer with increased surface area and/or porosity. In such embodiments, the method of the disclosure as described herein further comprises separating the unreacted coordination polymer precursors from the coordination polymer composition. A variety of techniques can be used on for separation. For example, in certain embodiments, the separation may be by filtration, centrifugation, sonication, gravity assist, or chromatography (e.g., gel filtration chromatography). In some embodiments, the coordination polymer composition may be further treated with additional supercritical CO₂. In some other embodiments, the unreacted coordination polymer precursors are collected and provided to the mixing section.

As noted above, the methods of the disclosure are particularly suitable for preparing coordination polymers, such as MOF, COF, or a combination thereof. Thus, in certain embodiments, the one or more coordination polymer precursors comprises a metal ion source and an organic linker. The metal ion source may be a metal oxide or metal salt. In certain embodiments, the metal ion source is selected from zirconium, copper, zinc, cobalt, indium, gallium, iron, nickel, aluminium, chromium, manganese, beryllium, magnesium, and an oxide or a salt of zirconium, copper, zinc, cobalt, indium, gallium, iron, nickel, aluminium, chromium, manganese, beryllium, magnesium, and the like. In certain embodiments, the metal ion source is zirconyl chloride octahydrate (ZrOCl₂.8H₂O). A variety of organic linkers may be used. Examples of the organic linkers include, but are not limited to, a carboxylic acid (such as terephthalic acid, terephthalic acid with one or more additives/modulators such as nitrogen dioxide or azanide or methane or chlorine or formic acid, trimesic acid, 2,5-dihydroxyterephthalic acid, 2-hydroxyterephthalic acid, biphenyl-3,3′,5,5′-tetracarboxylic acid, 1,3,5-tris(4-carboxyphenyl)benzene, 2,6-naphthalenedicarboxylic acid, 9,10-anthracenedicarboxylic acid, [1,1′:4′,1″]terphenyl-3,3″,5,5″-tetracarboxylic acid, 3,3′,5,5′-tetracarboxydiphenylmethane, 1,2,4,5-tetrakis(4-carboxyphenyl)-benzene, malonic acid, butanedioic acid, pentanedioic acid, citric acid, oxalic acid, fumaric acid, pentetic acid, 1,3,5,7-adamantanetetracarboxylic acid, and the like), adenosine diphosphate, an imidazole derivative (such as imidazole, 2-methylimidazole, tri(4-imidazolylphenyl)amine, and the like). In certain embodiments, the organic linker is terephthalic acid. Other examples of metal ion source and/or the organic linker include any one of those disclosed in H. Furukawa et al., Science 2013, 341:1230444, which is incorporated by reference in its entirety. Examples of metal ion source include, but are not limited to, Zn₄O(CO₂)₆, Zn₃O₃(CO₂)₃, Mg₃O₃(CO₂)₃, Co₃O₃(CO₂)₃, Ni₃O₃(CO₂)₃, Mn₃O₃(CO₂)₃, Cu₂(CO₂)₄, Zn₂(CO₂)₄, Fe₂(CO₂)₄, Mo₂(CO₂)₄, Cr₂(CO₂)₄, Co₂(CO₂)₄, Ru₂(CO₂)₄, Zr₆O₄(OH)₄—(CO₂)₁₂, Zr₆O₈(CO₂)₈, In(C₅HO₄N₂)₄, Na(OH)₂(SO₃)₃, Cu₂(CNS)₄, Zn(C₃H₃N₂)₄, Ni₄(C₃H₃N₂)₈, Al(OH)(CO₂)₂, Al(OH)(CO₂)₂, VO(CO₂)₂, Zn₃O₃(CO₂)₃, Mg₃O₃(CO₂)₃, Co₃O₃(CO₂)₃, Ni₃O₃(CO₂)₃, Mn₃O₃(CO₂)₃, Fe₃O₃(CO₂)₃, and Cu₃O₃(CO₂)₃. The one or more coordination polymer precursors, in certain embodiments, further comprises a solvent.

Another aspect of the disclosure provides systems that are useful to carry out the methods of the disclosure. Such systems include: a mixing section having a first inlet connected to a precursor supply, a second inlet connected to a supercritical CO₂ supply, and a first outlet; and a continuous flow reactor having an inlet connected to the outlet of the mixing section and an outlet.

In certain embodiments of the system, the supercritical CO₂ supply comprises a supercritical CO₂ pump connected to the second inlet of the mixing section. The precursor supply, in certain embodiments, comprises one or more precursor pumps connected to the first inlet of the mixing section. The reactor may be maintained at a temperature in a range of −20° C. to 600° C. In certain embodiments, the temperature is in a range of 25° C. to 600° C. In certain embodiments, the temperature is in a range of 80° C. to 160° C., or 100° C. to 140° C., or 110° C. to 130° C., or 120° C. The reactor may be maintained at a pressure in a range of 0 MPa to 30 MPa. For example, in certain embodiments, the pressure is in a range of 7.3 MPa to 30 MPa. In certain embodiments, the pressure is in a range of 7.3 MPa to 20 MPa, 7.3 MPa to 15 MPa, 8 MPa to 12 MPa, 9 MPa to 11 MPa, or 10 MPa.

In certain embodiments as otherwise described herein, the reactor is maintained at a temperature in a range of 90° C. to 150° C. and at a pressure in a range of 8.5 MPa to 11 MPa. In certain embodiments, the reactor is maintained at a temperature in a range of 110° C. to 130° C. and at a pressure in a range of 9 MPa to 11 MPa.

Thus, in certain embodiments as otherwise described herein, the reactor is operated at a flow rate of 0.1 mL/min to 100 mL/min. For example, in certain embodiments, the mixture is provided to the reactor at a flow rate of 0.1 mL/min to 50 mL/min, or 1 mL/min to 30 mL/min.

The system of the disclosure, in certain embodiments, further comprising a pressure regulator downstream from the outlet of the continuous flow reactor. For example, the pressure regulator may be a back pressure regulator. The system of the disclosure, in certain embodiments, may further comprise a heat exchanger in substantial thermal contact with the outlet of the continuous flow reactor.

In certain embodiments, system of the disclosure may also further comprise a collection vessel, e.g., upstream from the back pressure regulator. Such collection vessel may be downstream from the heat exchanger. The collection vessel may include a filter (e.g., a size exclusion filter). In certain embodiments, the collection vessel comprises an inlet, and the system further comprises a second the supercritical CO₂ supply connected to the inlet of the collection vessel. The system of the disclosure in certain embodiments may also further comprise a second collection vessel downstream from the back pressure regulator. The second collection vessel, for example, may be configured to collect effluent. The second collection vessel, for example, may also further comprise an outlet connected to the precursor supply.

The description of embodiments of the disclosure is not intended to be exhaustive or to limit the disclosure to the precise form disclosed. While the specific embodiments of, and examples for, the disclosure are described herein for illustrative purposes, various equivalent modifications are possible within the scope of the disclosure, as those skilled in the relevant art will recognize.

### Definitions

The following terms and expressions used herein have the indicated meanings.

The terms “a,” “an,” “the” and similar referents used in the context of describing the invention (especially in the context of the following claims) are to be construed to cover both the singular and the plural, unless otherwise indicated herein or clearly contradicted by context. Recitation of ranges of values herein is merely intended to serve as a shorthand method of referring individually to each separate value falling within the range. Unless otherwise indicated herein, each individual value is incorporated into the specification as if it were individually recited herein. Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect.

All methods described herein can be performed in any suitable order of steps unless otherwise indicated herein or otherwise clearly contradicted by context. The use of any and all examples, or exemplary language (e.g., “such as”) provided herein is intended merely to better illuminate the invention and does not pose a limitation on the scope of the invention otherwise claimed. No language in the specification should be construed as indicating any non-claimed element essential to the practice of the invention.

Unless the context clearly requires otherwise, throughout the description and the claims, the words ‘comprise’, ‘comprising’, and the like are to be construed in an inclusive sense as opposed to an exclusive or exhaustive sense; that is to say, in the sense of “including, but not limited to”. Words using the singular or plural number also include the plural and singular number, respectively. Additionally, the words “herein,” “above,” and “below” and words of similar import, when used in this application, shall refer to this application as a whole and not to any particular portions of the application.

As will be understood by one of ordinary skill in the art, each embodiment disclosed herein can comprise, consist essentially of or consist of its particular stated element, step, ingredient or component. As used herein, the transition term “comprise” or “comprises” means includes, but is not limited to, and allows for the inclusion of unspecified elements, steps, ingredients, or components, even in major amounts. The transitional phrase “consisting of” excludes any element, step, ingredient or component not specified. The transition phrase “consisting essentially of” limits the scope of the embodiment to the specified elements, steps, ingredients or components and to those that do not materially affect the embodiment.

Unless otherwise indicated, all numbers expressing quantities of ingredients, properties such as molecular weight, reaction conditions, and so forth used in the specification and claims are to be understood as being modified in all instances by the term “about.” Accordingly, unless indicated to the contrary, the numerical parameters set forth in the specification and attached claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements.

Some embodiments of this invention are described herein, including the best mode known to the inventors for carrying out the invention. Of course, variations on these described embodiments will become apparent to those of ordinary skill in the art upon reading the foregoing description. The inventor expects skilled artisans to employ such variations as appropriate, and the inventors intend for the invention to be practiced otherwise than specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

The term “precursor” or “precursor supply” refers to one or more compounds that participate in the reaction (i.e., reactants or substrates). For example, coordination polymer precursors may include metal ion source(s) and organic linker(s). In certain embodiments, precursors also include reagents, catalysts, solvents and other compounds that are useful to carry out the reaction. One of skill in the art would be able to select the coordination polymer precursors in order to arrive at the desired coordination polymer.

### EXAMPLES

Materials: All chemical materials were obtained from the indicated suppliers without additional purification and stored under recommended conditions. The UiO-66 MOF precursor materials are prepared following previously reported methods utilizing the less toxic zirconyl chloride octahydrate, ZrOCl₂.8H₂O (Sigma Aldrich, 98%) metal base compared to the more commonly used ZrCl. The metal precursor reactant 0.1 mol (35.40 g) ZrOCl₂.8H₂O was dissolved in 200 mL (2.58 mol) of N,N-dimethylformamide (DMF) anhydrous (Sigma-Aldrich, 99.8%) and 1 mL of acetic acid (Sigma-Aldrich, 99%) by stirring, and sonicated for 5 min in an ultrasonic bath. The organic precursors, 0.1 mol (18.24 g) H₂BDC and 200 mL (2.58 mol) of DMF, were combined, stirred in a second flask, and also ultrasonically treated for 5 min.

Reactor Configuration.

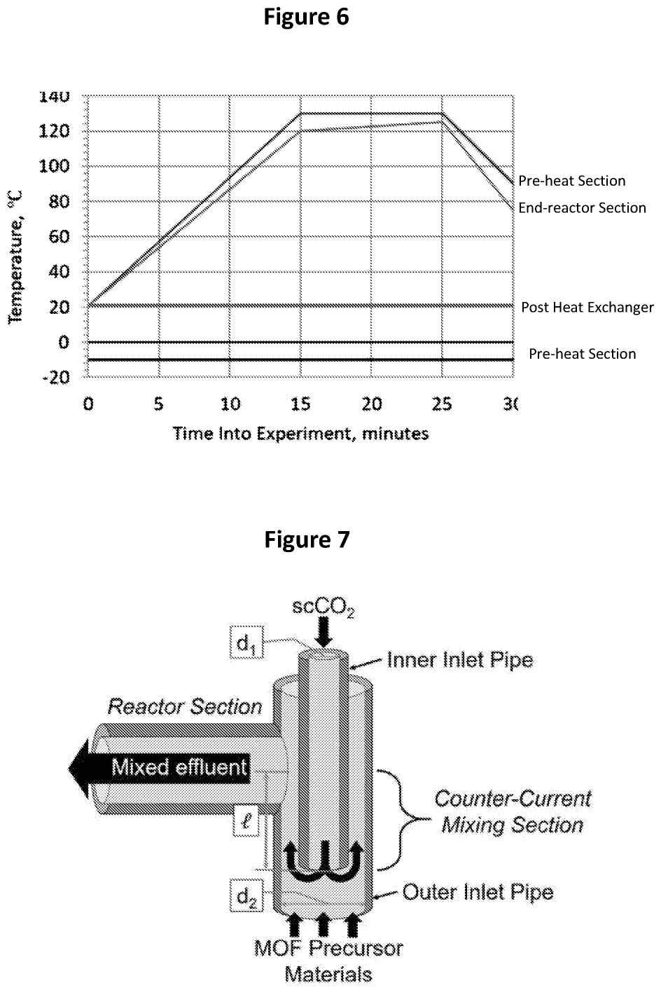

To rapidly create an environment favorable for MOF synthesis, preferably the thermal and mass transfer between the scCO₂ and MOF precursor is optimized and the reactor design is considered. For example, the design considerations include (1) equilibrium solubility to define the maximum amount of scCO₂ that can be dissolved into the MOF precursors, (2) mass transfer to determine the rate at which the scCO₂ dissolves into the precursors, and (3) heat transfer to define the rate at which the scCO₂ heats the precursors. A counter-current mixing (CCM) configuration was chosen due to its simplicity and its previous use in scH₂O reactors. FIG. 7 presents a CCM schematic. For a given CCM geometry, six key variables influence whether the effluent will be fully mixed before reaching the reactor section: (i) the temperature of scCO₂; (ii) the reactor pressure; (iii) the flow rates of scCO₂ and MOF precursor materials; (iv) the inner inlet pipe's inner diameter, d₁; (v) the outer inlet pipe's inner diameter, d₂; and (vi) the length of the mixing section, I. Here, the mixing section length is defined as the distance from the end of the inner inlet pipe to the reactor section pipe's centerline. These six variables determine the effluent's mass transfer time, heat transfer time, and convective time. The heat and mass transfer processes should be completed within the mixing section before the effluent enters the reactor section.

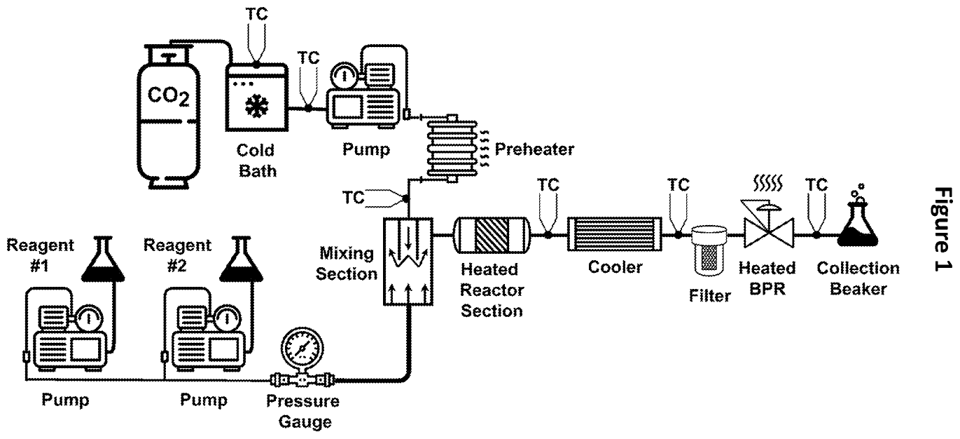

The continuous-flow MOF synthesis reactor, shown in FIG. 1, can operate between 298-873 K (25 to 600° C.) and 0.101-30 MPa. Thermocouples (type K, Omega) connect to a data acquisition module (TC-08, Omega). The data acquisition module was connected to a computer equipped with recording software (PicoLog v.6.1, Pico Technology). All piping and connections were high pressure rated 316 stainless steel (High-Pressure Equipment, Inc.). Two high-performance liquid chromatography (HPLC) pumps (model 515, Waters Corp.) initially filled the reactor with DI water, and the reactor was pressurized to 10 MPa. The reactor was pressurized using a back-pressure regulator (BPR) (Tescom 26-1700, Branom Instrument Co) and measured using a vibration-resistant gauge (McMaster-Carr).

Once the reactor was pressurized, CO₂ was supplied from a gas cylinder (99.99% purity, Praxair). At ambient temperature, the CO₂ was in the vapor phase at 298 K and 3.45 MPa. The CO₂ HPLC pump (model 305, Gilson) is typically used for pumping liquid, so the CO₂ had to be condensed to the liquid phase before entering the pump. A calcium chloride cold bath (83-87%/technical grade, McMaster-Carr) was used to provide sufficient cooling (263-268 K) to ensure that liquid CO₂ entered the pump. Following the CO₂ pump, the liquid CO₂ was heated above the critical temperature by a cartridge heater (800 W-240 V, Tempco) and power control console (Tempco). After the scCO₂ had reached 393 K (120° C.) in steady-state conditions, the HPLC pumps were switched to MOF precursor materials and ran at 10 mL·min⁻¹. To isolate the role of scCO₂ as a heating mechanism, the MOF precursors were not preheated. The ambient temperature MOF precursors were combined in a T-coupling before entering the mixing section, where they then were mixed with scCO₂. The mixture was then passed through the reactor section. Heat loss from the reactor section was minimized by wrapping the section with a heating cable set at 351 K with a programmable temperature controller and a layer of ceramic insulation (McMaster-Carr). A heat exchanger (model 2000W Modular Liquid Cooling System, Koolance) cools the effluent to ambient temperature. A teetype filter with 0.5 μm sintered 316 stainless steel element (Swagelok) collected MOFs. The effluent exited the reactor through the BPR. Since the throttling action of the BPR can lead to dry ice formation, a wrap heater was used to avoid this problem. Downstream of the BPR, a flask collected effluent and gaseous CO₂ was separated naturally. An outline of the temperatures through the reactor during the experiment can be seen in FIG. 6.

Characterization. After collection, the material was activated by following standard procedures. Particles were washed with DMF three times to remove unreacted precursors. The particles were then washed three times with ethanol and centrifuged (Eppendorf, 5910 R) at 10000 rpm for 3 min. The UiO-66 product was vacuum-dried at 393 K overnight. Final product yield was measured using an analytical balance (Mettler Toledo, ME54TE).

A 15 mg homogeneous layer of the activated sample was dispersed on a glass slide for powder X-ray diffraction (PXRD) crystallinity characterization. PXRD spectra were collected using a Bruker D8 Discover with IμS 2-D detector at 50 kV, 1000 μA for Cu Kα (λ=1.5418 Å) radiation at room temperature over the angular range from 5°-60° at a scanning rate of 2 deg·min⁻¹. For physisorption analysis, 150 mg of the activated sample was further evacuated in a vacuum oven at 383 K for 8 h, transferred to a preweighed sample tube, and degassed on a micrometrics Smart VacPrep 067 degassing station at 383 K until the outgassing rate was <5 μmHg. The sample tube was then reweighted to obtain a consistent mass for the degassed sample. N2 isotherms were obtained using a micrometrics 3Flex machine at 77 K using a liquid nitrogen bath. Ultrahigh-purity grade, 99.999%, N2 gas was used throughout the experiment (Praxair). Morphology analysis was performed on an FEI Sirion XL30 scanning electron microscope (SEM) at 5 kV. For the SEM study, 15 mg of the activated sample was dispersed in ethanol and pipetted onto an oxygen plasma cleaned silicon wafer to form a film. The wafer was then placed under a vacuum at room temperature overnight.

### Results and Discussion.

Heat and Mass Transfer within the Mixing Section. The present disclosure provides a system for the continuous production of MOFs using scCO₂. For the heat and mass transfer analysis, the MOF precursors are assumed to consist solely of DMF, as the influent DMF ratio to other precursor materials ranges from a 20:1 up to a 133:1 ratio. Values used in the analysis, presented in Table 1, were taken as close to the reactor's operating conditions as possible, though the DMF properties are frequently not defined above atmospheric pressure. As DMF remains in the liquid phase, it can be considered an incompressible fluid, and thus, thermodynamic properties such as specific heat, density, and thermal conductivity will experience less than a 1% change between atmospheric pressure of 0.1 MPa and the 10 MPa pressure used in this study. In addition, values for the mass diffusivity, D, were not found for DMF-CO₂ mixtures, so mass diffusivity information for DMF-H₂O mixtures was used as a substitute.

TABLE 1
Properties Used for Designing the scCO₂
Continuous-Flow MOF Synthesis Reactor

| Property | Value (unit) | |
|---|---|---|
| Mass fraction equilibrium solubility | 0.29715 | (kg) |
| of liquid CO₂ in CO₂-DMF Mixture | | |
| at 393 K, 10 MPa | | |
| Mass diffusivity at 313 K, 0.101 | 1.63 ± 0.02 | (m2 · s⁻¹) |
| MPa (99.92% DMF, 0.08% H₂O) | | |
| Density of DMF at 351 K, 10 MPa | 894.28 | (kg · m⁻³) |
| Density of DMF at 298 K, 10 MPa | 950.41 | (kg · m⁻³) |
| Dynamic Viscosity of DMF at | 4.581 × 10⁻⁴ | (kg · m⁻¹ · s⁻¹) |
| 351 K, 0.101 MPa^{a} | | |
| Specific heat capacity of DMF | 2171.0 | (J · kg⁻¹ · K⁻¹) |
| at 351 K, 0.101 MPa^{a} | | |
| Thermal Conductivity of DMF | 0.1735 | (W · m⁻¹ · K⁻¹) |
| at 351 K, 0.101 MPa^{a} | | |
| Thermal Diffusivity of DMF | 8.916 | (m2 · s⁻¹) |
| at 351 K, 0.101 MPa^{a} | | |
| Density of CO₂ at 351 K, 10 MPa | 226.08 | (kg · m⁻³) |
| Density of CO₂ at 273 K, 10 MPa | 974.05 | (kg · m⁻³) |

^{a}Temperature was interpolated from experimental data provided in reference.

The inlet temperature of CO₂ (T=393 K) and reactor pressure (P=10 MPa) were chosen for three reasons. First, these conditions keep the CO₂ in the supercritical phase. Second, at 10 MPa, scCO₂ properties can be manipulated but are not so sensitive as to require high-precision controls. Third, 393 K provides sufficient temperature to enable the MOF formation reaction without causing thermal degradation of the precursors. At this pressure and temperature, scCO₂ is to the right of the Widom line and thus behaves similarly to superheated vapor. The precursor materials enter as a compressed liquid; they are not preheated and are at P=10 MPa. Thus, the system essentially consists of bubbles of scCO₂ vapor rising through liquid DMF.

To ensure the DMF liquid is fully saturated with scCO₂, vapor-liquid equilibrium (VLE) data were used to select the flow rates of scCO₂ and DMF. Few VLE solubility studies of DMF-Co₂ mixtures are reported in the literature. Most recently, it was reported that DMF-CO₂ VLE data at T=305 to 353 K, P=0.101 to 2 MPa. At this low-pressure, CO₂ never reaches the supercritical phase.

Three isothermal VLE experiments at 293, 313, and 338 K were performed, and the Lewis Randall rule was applied to calculate the fugacity of the CO₂ in the liquid phase. Then, the Clapeyron-Clausius relationship was used to extrapolate the liquid phase fugacity to 393 K. Finally, the Lewis Randall rule was used to estimate the liquid phase fraction of CO₂ at 10 MPa and 393 K. This resulted in an equilibrium mass fraction of 0.2408 g of CO₂ in the liquid DMF. The volumetric flow rates, V, for the CO₂ and DMF are set to of 20 mL·min⁻¹, which resulted in mass flow rates, \dot{m}, of 0.316 g·s⁻¹ for DMF and 0.324 g·s⁻¹ for CO₂.

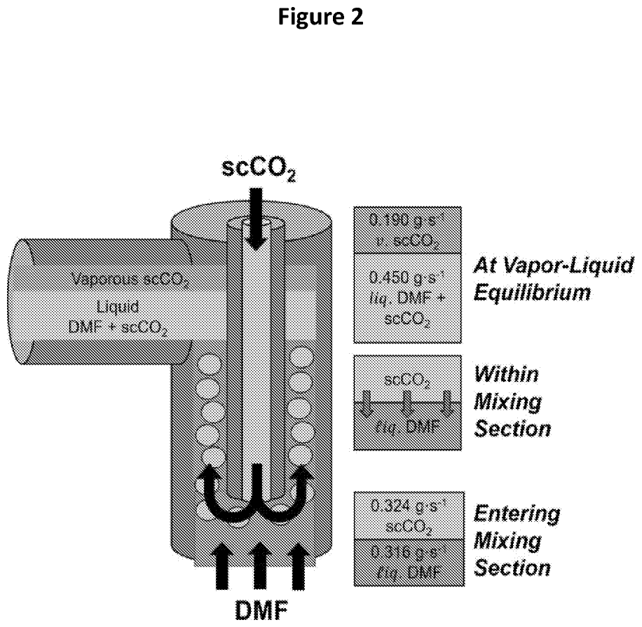

Given the almost equal mass flow rates but lower mass fraction solubility, the DMF might not dissolve all the scCO₂. This results in excess scCO₂, in turn resulting in a two-phase effluent. FIG. 2 shows a schematic of the CCM section reaching the vapor-liquid equilibrium. The mass-transfer rate of scCO₂ into the DMF liquid determines the rate of approach to DMF-CO₂ VLE. The mixture average temperature leaving the CCM is determined using specific heats and mass flow rates at the average temperature of 351 K (77.85° C.). Property values used from this point are calculated based on this average temperature unless otherwise noted. The scCO₂ bubble diameter, d_{b}, is defined as the inner inlet pipe's inner diameter, d₁, 1.52×10⁻³ m (⅛ in. outer diameter). This size pipe was selected because it balanced the need for a small pipe diameter leading to faster diffusion, with rigidity to keep the tube concentric within the larger mixing section inlet pipe. The bubble terminal velocity, v_{o,b}, was found using equation (1) with the use of drag coefficient, CD.

$${v}_{o , b} = \sqrt{\frac{4 \cdot {d}_{b} \cdot ( {ρ}_{{CO}_{2}} - {ρ}_{DMF} ) \cdot g}{3 \cdot {C}_{D} \cdot {ρ}_{DMF}}} \qquad ( 1 )$$

The scCO₂ bubble's terminal velocity was found to be v_{o,b}=0.168 m·s⁻¹. With a defined DMF dynamic viscosity, μDMF, the Reynolds number, Re, was calculated as 497, according to equation (2).

$$Re = \frac{{d}_{b} \cdot {v}_{o , b} \cdot {ρ}_{DMF}}{{μ}_{DMF}} \qquad ( 2 )$$

Next, using equation (3) and equation (4), the Schmidt number, Sc, and Grashof number, Gr, were calculated as 316 and 1.15×10⁵, respectively.

$$Sc = \frac{{μ}_{DMF}}{{ρ}_{DMF} \cdot {𝒟}_{{CO}_{2} , DMF}} \\ and \qquad ( 3 )$$

$$Gr = \frac{{d}_{b}^{3} \cdot {ρ}_{DMF} \cdot g \cdot ( {ρ}_{{CO}_{2} , inlet} - {ρ}_{DMF , inlet} )}{{μ}_{DMF}^{2}} \qquad ( 4 )$$

With these results, the mass-transfer was within the forced convection regime with negligible free convection contribution, Re≥0.4 Gr^{1/2} Sc^{-1/6}. The Peclet number, Pe, was calculated, Pe=Re·Sc, as 1.57×10⁵. The relationship shown in equation (5) for Sherwood number, Sh, was used resulting in Sh=85.85. This yields a convective mass transfer coefficient of a single scCO₂ bubble in DMF, h, of 0.0821 kg·m⁻²·s⁻¹. Thus, the characteristic time for the mass of a bubble of scCO₂ to transfer in DMF was 2.15 s.

$$sh = \frac{h \cdot {d}_{b}}{{𝒟}_{{CO}_{2} , DMF}} = {( 4 + 1.21 \cdot {Pe}^{2 / 3} )}^{1 / 2} \qquad ( 5 )$$

Next, the time it would take for the heat transfer from the scCO₂ to DMF was determined. The Prandtl number, Pr, defined according to equation (6).

$$Pr = \frac{{μ}_{DMF} \cdot {c}_{p , DMF}}{k} \qquad ( 6 )$$

where c_{p,DMF} is the specific heat in J·kg⁻¹·K⁻¹ of DMF and k is the thermal conductivity in W·M⁻¹·K⁻¹ resulting in Pr=5.76. The Lewis number, Le, in terms of Pr and Sc,

$$Le = \frac{Sc}{Pr}$$

was found to be 54.7. This result shows that heat transport will occur over 50 times faster than mass-transport within the mixing section. The characteristic time it would take the heat of a scCO₂ bubble to transfer into the DMF at the defined conditions is 0.0393 s.

On the basis of the calculated characteristic times, the two remaining CCM geometric parameters were set. The outer pipe's inner diameter, d₂, was set as 5.159×10⁻³ m (⅜ in. outer diameter), and mixing section length, l, was set to 3.81×10⁻² m (1.5 in.). These dimensions created a sufficiently long convective time for both heat and mass transfer to be completed before exiting the mixing section. The convective time for the mixture to flow through the mixing section was 2.39 s.

Table 2 summarizes the CCM section variables and characteristic times; these were deemed sufficient to provide the rapid heating and mass transfer desired before the mixture entered the reactor section.

TABLE 2
Resulting Terms, Including Time Scales, for the Continuous-
Flow MOF Synthesis Reactor Using scCO₂ Mixing Section

| Calculated Term | | Result (unit) |
|---|---|---|
| Mixing | Temperature of scCO₂ | 393 (K) |
| Section | Reactor pressure | 10 (MPa) |
| Variables | Flow rate of scCO₂ and MOF | 20 (mL · min⁻¹) |
| | precursor materials, V | |
| | Inner diameter of the inner pipe, d₁ | 1.52 × 10⁻³ (m) |
| | Inner diameter of the outer pipe, d₂ | 5.16 × 10⁻³ (m) |
| | Length of mixing section, / | 3.81 × 10⁻² (m) |
| | | or 1.5 (in) |
| Mass | Effluent equilibrium temperature | 351.1 (K) |
| Transfer | Supercritical CO₂ bubble terminal | 0.168 (m · s⁻¹) |
| | velocity, v_{o,b} | |
| | Reynolds number, Re | 497.6 |
| | Schmidt number, Sc | 315.7 |
| | Grashof number, Gr | 1.15 × 10⁵ |
| | Peclet number, Pe | 1.57 × 10⁵ |
| | Sherwood number, Sh | 85.85 |
| | Convective mass transfer | 0.0821 |
| | coefficient, h | (kg · m⁻² · s⁻¹) |
| Heat | Prandtl number, Pr | 5.76 |
| Transfer | Lewis number, Le | 54.7 |
| Charac- | Time for equilibrium mass transfer | 2.15 (s) |
| teristic | of CO₂ into DMF | |
| Times | Time for equilibrium heat transfer | 0.0393 (s) |
| | of CO₂ into DMF | |
| | Mixture residence time in the mixing | 2.39 (s) |
| | section | |

As mentioned earlier, a drawback of continuous flow scH₂O MOF synthesis is the high energy consumption due to a high critical temperature (647 K). The energy, E, consumption required to increase the temperature of H₂O can be easily realized in a simple first law analysis where E=q=m·cₚ·ΔT. With room temperature and atmospheric pressure H₂O (298 K, 0.101 MPa) being pumped into a reactor at a flow rate of 20 mL·min⁻¹ for 1 h, the mass of the H₂O was 1209 g. Using cₚ values from NIST REFPROP at the commonly used operating pressure of 24 MPa, the energy required to increase the temperature of the H₂O above the critical point to an operating temperature of 673 K (400° C.) is 3037 kJ. Using the same method for the scCO₂ reactor results in an energy consumption of 393 kJ or 13% of the energy required for a scH₂O reactor. Additionally, a hydrothermal reactor with a target operating temperature of 418 K results in an energy consumption of about 603 kJ. Thus, the scCO₂ reactor consumes only 65% of the energy requirement compared to a hydrothermal reactor. This first-order analysis demonstrates that the continuous flow scCO₂ reactor has the potential to be more energy-efficient than a comparable continuous flow scH₂O or hydrothermal reactor.

UiO-66 MOF Synthesis. Under the described experimental and post-processing conditions, the UiO-66 synthesis yield was measured as 8.71 g in 5 min, for a production rate of 104 g·h⁻¹. It is believed, this production rate of UiO-66 is higher than any other values reported in the literature. Table 3 outlines the methods used to synthesize the UiO-66 MOF as well as the reaction time, production rate, temperature constraints, and solvent recycling capability.

TABLE 3
Comparison between Methods to Synthesize Zirconium-Based
UiO-66 MOF and Reaction Time, Production Rate,
Synthesis Temperature, and Option to Recycle Solvents

| | | Production | Synthesis |
|---|---|---|---|
| | Reaction | rate | temp. |
| Synthesis Method | Time | (g · h⁻¹) | ≤120° C. |
| Batch—Solvothermal | 24 h | Unreported, | Yes |
| | | estim. <0.1 | |
| Mechanochemical | 75 min | 2.28 | Yes |
| Continuous flow—Microwave | 7 min | 14.40 | Yes |
| Continuous flow—Microfluidics | 15 min | Unreported, | No |
| | | estim. <0.1 | |
| Continuous flow—Solvothermal | 10 min | 1.68 | Yes |
| Continuous flow—Supercritical H₂O^{a} | <5 s | 26.63 | No |
| Continuous flow—Supercritical CO₂ | <3 s | 104 | Yes |

^{a}UiO-66 MOF synthesis has not been reported using this method, and values are provided for zinc-based MOF ZIF-8.

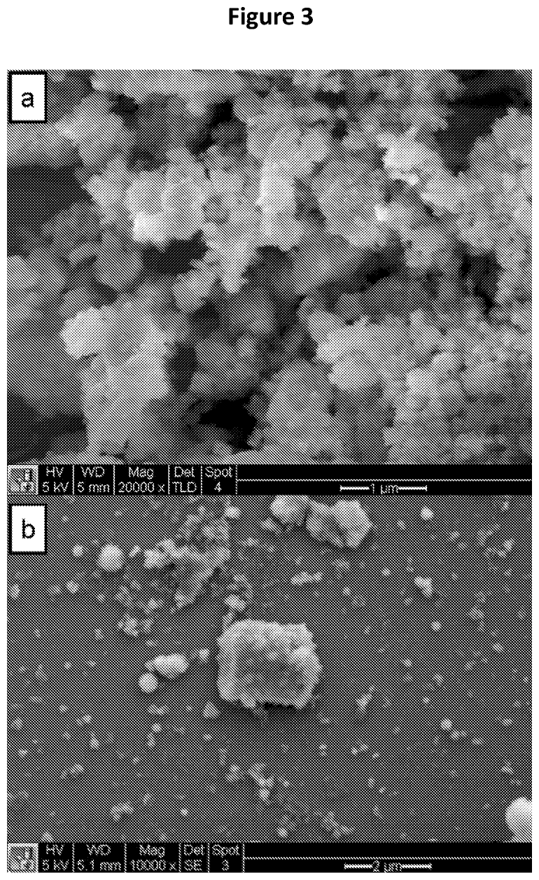

The synthesized UiO-66 properties were found to be consistent with those reported in the literature. Morphology was examined using scanning electron microscopy (SEM) imaging shown in FIG. 3. Using the commercial Bruker Eva software estimation from the Scherrer formula applied to the PXRD spectra showed average particle size to be 211 nm, which agrees with SEM images taken, FIG. 3a. SEM image FIG. 3b highlights larger particles up to 1000 nm in size, which agrees with previous reports of continuous flow methods for UiO-66 MOF synthesis. UiO-66 has cubic symmetry that frequently appears as cubic crystals, as indicated in FIG. 3.

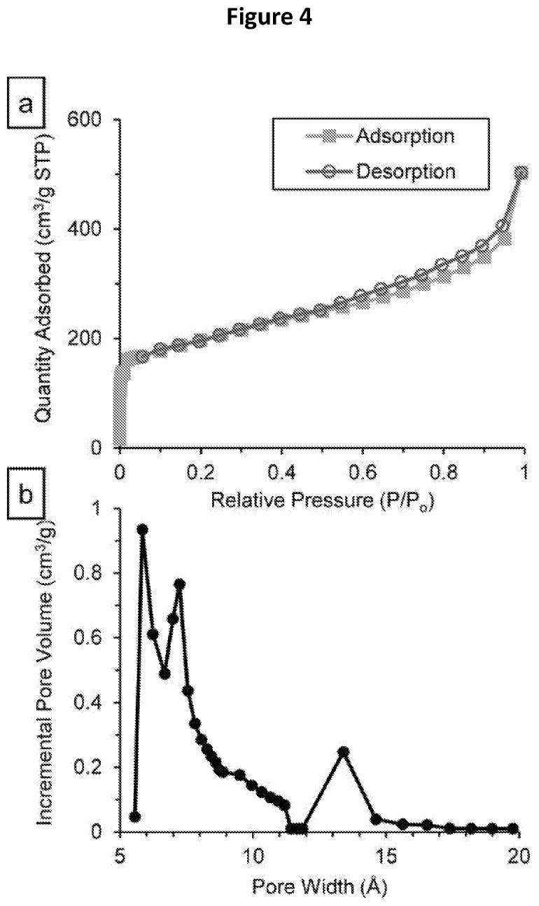

Physisorption analysis via N₂ gas isotherms generated the results shown in FIG. 4a. Using the Brunauer-Emmett-Teller (BET) equation, the surface area was calculated as 1109.6 m²·g⁻¹. Using the Horvath-Kawazoe method, the pore size distribution was determined, FIG. 4b, and the total pore volume was found to be 0.381 cm³·g⁻¹. The pore size distribution was consistent with prior UiO-66 reports with the centric octahedral pore occurring at ˜12 Å and the corner tetrahedral pores occurring at 8 Å that are connected through triangular pores occurring at 6 A. The broad distribution of pores from 8 to 10 Å is larger compared to a batch synthesis method but is consistent with other continuous-flow synthesis methods.

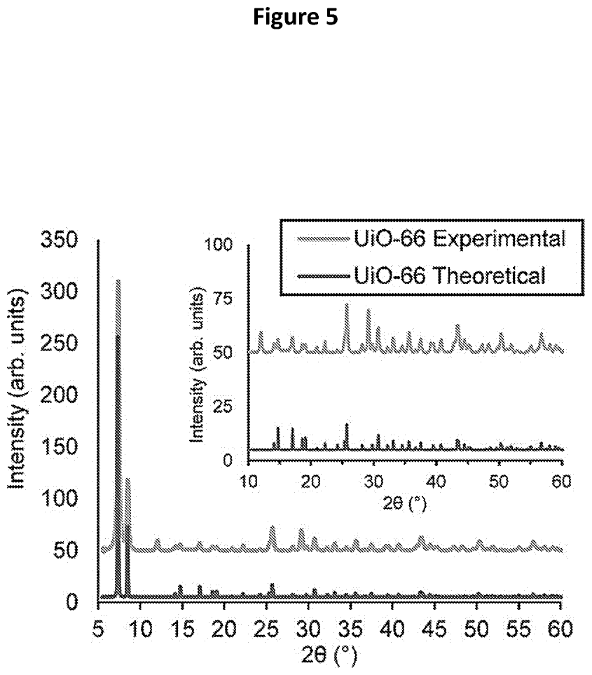

FIG. 5 shows that the powder X-ray diffraction (PXRD) spectra of the sample match the International Centre for Diffraction Data (ICDD) UiO-66 reference. In achieving the industrially viable production of MOFs, synthesis is only one of the challenges; the activation of the synthesized frameworks is crucial to obtain maximum use of the porosity of the material. Material activation is a time consuming process that involves a solvent exchange via washing and centrifugation, followed by 2-12 h of degassing performed in a vacuum chamber. Previous work has used scCO₂ as a MOF activation medium. This suggests the possibility of the scCO₂ acting as an activation medium to reduce the ordinarily 12-hour degassing time. In the experiments of the disclosure, 10 min of degassing at 393 K in a vacuum oven provided the same surface area and crystallinity as a sample degassed at the same temperature for 12 h. A sample dried at room temperature for 6 h, showed PXRD spectra characteristic peaks at 2θ=7.34° and 8.48° but generally showed a more amorphous structure, possibly due to guest inclusion inside the MOF pores. Given these findings, the ongoing investigation within this reactor design includes the activation of synthesized MOFs using scCO₂.

Two issues that address the sustainability of a process are (1) the toxic hazard associated with the raw materials used and (2) the amount and toxicity of waste generated. The present process uses a less toxic Zr-metal precursor. One measure of toxicity is the mean lethal dose (LD₅₀) metric. The Zr-metal precursor used for this study, ZrOCl₂.8H₂O, has an LD₅₀ of 3500 mg·kg⁻¹, while the commonly used Zr-metal precursor for UiO-66 MOF synthesis, ZrCl₄, has an LD₅₀ of 1688 mg·kg⁻¹. While the LD₅₀ value is only one measure going into a full life cycle analysis, the selection of raw materials is an important consideration for sustainable MOF synthesis. With respect to waste, the CO₂ naturally flashes into the vapor phase as the pressure is relieved. The separation of CO₂ and DMF is clean as the VLE solubility of CO₂ in DMF at 0.1 MPa is below 0.01%. This separation opens the opportunity to recycle the DMF. Recycling of unused reagents is not typical in solvothermal methods. Overall, it was calculated that in comparison to the scCO₂ method of the disclosure, a continuous flow microwave method creates two times more DMF waste while a continuous flow solvothermal method creates six times more DMF waste.

In conclusion, the disclosure provides an innovative approach for the rapid production of MOFs in an environmentally friendly and scalable continuous-flow scCO₂ reactor. The approach successfully synthesized the zirconium-based UiO-66 MOF at a production rate of 104 g·h⁻¹ with a reaction time under three seconds. In certain embodiments of the disclosure, the scCO2 in a continuous-flow reactor can be used as a means for large-scale MOF manufacturing. Scalable synthesis methods enable the widespread integration of MOFs into commercial applications like energy storage devices, targeted drug delivery, and gas capture. In certain embodiments of the disclosure, other materials, such as zinc or copper-based MOFs may also be prepared.

Some embodiments of various aspects of the disclosure are described herein, including the best mode known to the inventors for carrying out the methods described herein. Of course, variations on these described embodiments will become apparent to those of ordinary skill in the art upon reading the foregoing description. The skilled artisan will employ such variations as appropriate, and as such the methods of the disclosure can be practiced otherwise than specifically described herein. Accordingly, the scope of the disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

It will be apparent to those skilled in the art that various modifications and variations can be made to the materials and methods described here without departing from the scope of the disclosure. Thus, it is intended that the present disclosure cover such modifications and variations of this invention provided they come within the scope of the appended claims and their equivalents.

1. A method of preparing a coordination polymer composition under continuous flow conditions, the method comprising:
providing a supercritical carbon dioxide (CO₂) and one or more coordination polymer precursors to a mixing section to obtain a mixture of the supercritical CO₂ and one or more coordination polymer precursors; and
providing the mixture to a continuous flow reactor for a period of time sufficient to obtain the coordination polymer composition.

2. The method of claim 1, wherein the coordination polymer is metal-organic framework (MOF), covalent organic framework (COF), or a combination thereof.

3. The method of claim 1, wherein the reactor and the mixing section are maintained at a temperature sufficient to obtain the coordination polymer composition and/or maintain supercritical conditions.

4. The method of claim 3, wherein the sufficient temperature is in a range of 30° C. to 600° C.

5. The method of claim 1, wherein the reactor and the mixing section are maintained at a pressure sufficient to maintain supercritical conditions.

6. The method of claim 5, wherein the sufficient pressure is in a range of 7.3 MPa to 30 MPa.

7. (canceled)

8. The method of claim 1, wherein the mixture is provided to the reactor at a flow rate of 0.1 mL/min to 100 mL/min.

9. (canceled)

10. (canceled)

11. (canceled)

12. (canceled)

13. The method of claim 1, further comprising
providing gaseous CO₂ at a temperature and/or pressure sufficient to form liquid CO₂; and
maintaining liquid CO₂ at pressure and/or temperature sufficient to form supercritical CO₂.

14. The method of claim 1, further comprising providing gaseous CO₂ at a temperature and/or pressure sufficient to form supercritical CO₂.

15. (canceled)

16. (canceled)

17. The method of claim 1, further comprising removing CO₂ after obtaining the coordination polymer composition, and optionally further comprising recycling CO₂ to the mixing section as supercritical CO₂.

18. The method of claim 1, further comprising separating the unreacted coordination polymer precursors from the coordination polymer composition.

19. The method of claim 18, further comprising treating the coordination polymer composition with additional supercritical CO₂.

20. The method of claim 19, wherein treatment with additional supercritical CO₂ increases surface area and/or porosity of the coordination polymer composition.

21. (canceled)

22. The method of claim 18, wherein the unreacted coordination polymer precursors are collected and provided to the mixing section.

23. The method of claim 1, wherein the one or more coordination polymer precursors comprises a metal ion source and an organic linker.

24. The method claim 23, wherein the metal ion source is a metal oxide or metal salt.

25. (canceled)

26. The method of claim 23, wherein the organic linker is a carboxylic acid, adenosine diphosphate, imidazole or an imidazole derivative.

27. The method of claim 23, wherein the organic linker is terephthalic acid and/or the metal ion source is zirconyl chloride octahydrate (ZrOCl₂.8H₂O).

28. (canceled)

29. A system comprising:
a mixing section having a first inlet connected to a precursor supply, a second inlet connected to a supercritical CO₂ supply, and a first outlet; and
a continuous flow reactor having an inlet connected to the outlet of the mixing section and an outlet.

30. The system of claim 29, wherein the supercritical CO₂ supply comprises a supercritical CO₂ source connected to the second inlet of the mixing section and/or one or more precursor sources connected to the first inlet of the mixing section.

31-47. (canceled)
